(19) United States
(12) Patent Application Publication
(10) Pub. No.: US 2016/0052396 A1
(43) Pub. Date: Feb. 25, 2016

(54) ELECTRIC VEHICLE

(71) Applicant: Toyota Jidosha Kabushiki Kaisha, Toyota-shi (JP)

(72) Inventor: Kazuya Tsuchiya, Toyota-shi Aichi-ken (JP)

(73) Assignee: TOYOTA JIDOSHA KABUSHIKI KAISHA, Toyota-shi Aichi-ken (JP)

(21) Appl. No.: 14/831,184

(22) Filed: Aug. 20, 2015

(30) Foreign Application Priority Data
Aug. 25, 2014 (JP) 2014-170519

(51) Int. Cl. B60L 3/00; B60L 11/18; H02P 3/06; H02P 31/00; H02P 1/16

(52) U.S. Cl. CPC B60L 3/0046; H02P 31/00; H02P 1/16; H02P 3/06; B60L 11/1872; Y10S 903/907

(57) ABSTRACT

When a temperature rise is required for only a first battery out of first and second batteries, a first relay is turned on to connect the first battery with a first booster circuit (i.e., connect the first battery with a motor side). When a temperature rise is required for only the second battery, on the other hand, a second relay is turned on to connect the second battery with a second booster circuit (i.e., connect the second battery with the motor side).

This application claims priority to Japanese Patent Application No. 2014-170519 filed 25 Aug. 2014, the contents of which is incorporated herein by reference.

### TECHNICAL FIELD

The present invention relates to an electric vehicle and more specifically relates to an electric vehicle equipped with a motor for running, a first battery, a first relay configured to connect and disconnect the first battery with and from the motor, a second battery and a second relay configured to connect and disconnect the second battery with and from the motor.

### BACKGROUND ART

A proposed configuration of such an electric vehicle includes a motor generator for running, a main battery, an optional battery (sub-battery), a first contactor placed between the main battery and the motor generator and a second contactor placed between the optional battery and the motor generator. In the state that the temperature of the main battery or the optional battery is other than ordinary temperature, the electric vehicle turns on the second contactor and turns off the first contactor, when the output of the optional battery is greater than the output of the main battery. The electric vehicle turns on the first contactor and turns off the second contactor, on the other hand, when the output of the optional battery is equal to or less than the output of the main battery (for example, JP 2008-29071A). In this electric vehicle, such control selects the greater-output battery out of the main battery and the optional battery and causes electric power to be supplied from the selected battery to the motor generator, thus suppressing a reduction of output for running.

### CITATION LIST

### Patent Literature

PTL 1: JP 2008-29071A

### SUMMARY OF INVENTION

### Technical Problem

In the case that a temperature rise-requiring battery that is a battery requiring a temperature rise out of the main battery and the optional battery has a smaller output, the prior art electric vehicle described above does not select the temperature-rise requiring battery. This reduces the frequency of discharge from the temperature rise-requiring battery and is likely to relatively extend the time required for a temperature rise of the temperature rise-requiring battery.

With regard to an electric vehicle equipped with two batteries, an object of the invention is to suppress an increase in time required for a temperature rise of a temperature rise-requiring battery.

### Solution to Problem

In order to solve at least part of the problems described above, the invention may be implemented by an electric vehicle of any of the following aspects.

According to one aspect of the invention, there is provided an electric vehicle equipped with a motor for running, a first battery, a first relay configured to connect and disconnect the first battery with and from the motor, a second battery, a second relay configured to connect and disconnect the second battery with and from the motor and a controller configured to control the motor and the first and the second relays, wherein when a temperature rise is required for one of the first and the second batteries, the controller specifies a battery requiring a temperature rise as a selected battery out of the first and the second batteries and controls the first relay and the second relay to connect the selected battery with the motor.

When a temperature rise is required for one of the first and the second batteries, the electric vehicle of the invention specifies the battery requiring a temperature rise (hereinafter referred to as “temperature rise-requiring battery”) as the selected battery out of the first and the second batteries, and controls the first and the second relays to connect the selected battery with the motor. This causes the electric power for driving the motor to be supplied from the temperature rise-requiring battery (selected battery) to the motor (i.e., discharged from the temperature-rise requiring battery), so as to raise the temperature of the temperature rise-requiring battery. This results in suppressing a relative increase in time required for a temperature rise of the temperature rise-requiring battery due to the less frequency of discharge from the temperature rise-requiring battery.

### BRIEF DESCRIPTION OF DRAWINGS

FIG. 1 is a configuration diagram illustrating the schematic configuration of an electric vehicle according to one embodiment of the invention;

FIG. 2 is a flowchart showing one example of a power supply control routine performed by an electronic control unit of the embodiment;

FIG. 3 is a diagram illustrating one example of an internal resistance estimation map;

FIG. 4 is a diagram illustrating one example of relationships between battery temperatures Tb1 and Tb2 of first and second batteries and basic values Wouttmp1 and Wouttmp2;

FIG. 5 is a diagram illustrating one example of relationships between states of charge SOC1 and SOC2 of the first and second batteries and correction factors kout1 and kout2;

FIG. 6 is a configuration diagram illustrating the schematic configuration of a hybrid vehicle according to a modification;

FIG. 7 is a configuration diagram illustrating the schematic configuration of another hybrid vehicle according to another modification; and

FIG. 8 is a configuration diagram illustrating the schematic configuration of yet another hybrid vehicle according to yet another modification.

### DESCRIPTION OF EMBODIMENTS

The following describes some aspects of the invention with reference to embodiments.

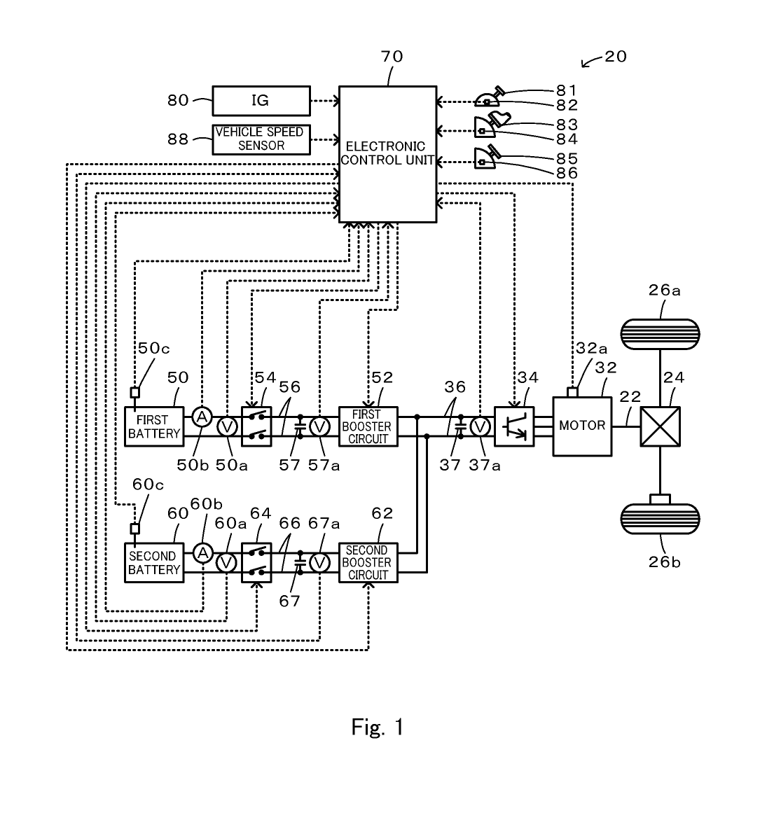

FIG. 1 is a configuration diagram illustrating the schematic configuration of an electric vehicle 20 according to one embodiment of the invention. As illustrated, the electric vehicle 20 of the embodiment includes a motor 32 that is provided as, for example, a synchronous motor generator and is configured to input and output power from and to a driveshaft 22 connected with drive wheels 26a and 26b via a differential gear 24; an inverter 34 that is configured to drive the motor 32; a first battery 50 that is provided as, for example, a lithium ion secondary battery; a first booster circuit 52 that is configured to boost the electric power from the first battery 50 and supply the boosted power to the inverter 34; a first relay 54 that is configured to connect and disconnect the first battery 50 with and from the first booster circuit 52; a second battery 60 that is provided as, for example, a lithium ion secondary battery; a second booster circuit 62 that is configured to boost the electric power from the second battery 60 and supply the boosted power to the inverter 34; a second relay 64 that is configured to connect and disconnect the second battery 60 with and from the second booster circuit 62; and an electronic control unit 70 that is configured to control the entire vehicle. According to this embodiment, the first battery 50 and the second battery 60 are respectively provided as high-capacity, high-power batteries.

The first booster circuit 52 and the second booster circuit 62 are respectively provided as known booster converters. The first booster circuit 52 is connected with a power line 36 that connects with the inverter 34 (hereinafter referred to as “drive voltage-based power line”) and with a power line 56 that connects with the first battery 50 via the first relay 54 (hereinafter referred to as “first battery voltage-based power line”) and is configured to boost the electric power on the first battery voltage-based power line 56 and supply the boosted power to the drive voltage-based power line 36, while stepping down the electric power on the drive voltage-based power line 36 and supplying the stepped-down power to the first battery voltage-based power line 56. The second booster circuit 62 is connected with the drive voltage-based power line 36 and with a power line 66 that connects with the second battery 60 via the second relay 64 (hereinafter referred to as “second battery voltage-based power line”) and is configured to boost the electric power on the second battery voltage-based power line 66 and supply the boosted power to the drive voltage-based power line 36, while stepping down the electric power on the drive voltage-based power line 36 and supplying the stepped-down power to the second battery voltage-based power line 66.

A smoothing capacitor 37 is connected with a positive electrode bus and a negative electrode bus of the drive voltage-based power line 36. A smoothing capacitor 57 is connected with a positive electrode bus and a negative electrode bus of the first battery voltage-based power line 56. A smoothing capacitor 67 is connected with a positive electrode bus and a negative electrode bus of the second battery voltage-based power line 66.

The electronic control unit 70 is implemented as a CPU-based microprocessor and includes a ROM that stores processing programs, a RAM that temporarily stores data, input/output ports and a communication port in addition to the CPU, although not being specifically illustrated. The electronic control unit 70 inputs, via the input port, a rotational position 8m of a rotor of the motor 32 from a rotational position detection sensor 32a configured to detect the rotational position of the rotor of the motor 32; phase currents Iu, Iv and Iw from a current sensor configured to detect phase currents flowing through the respective phases of a three-phase coil of the motor 32; a voltage VH of the capacitor 37 (voltage of the drive voltage-based power line 36) from a voltage sensor 37a placed between terminals of the capacitor 37; a voltage VL1 of the capacitor 57 (voltage of the first battery voltage-based power line 56) from a voltage sensor 57a placed between terminals of the capacitor 57; a voltage VL2 of the capacitor 67 (voltage of the second battery voltage-based power line 66) from a voltage sensor 67a placed between terminals of the capacitor 67; an electric current Is from a current sensor mounted on either the second battery voltage-based power line 66-side or the drive voltage-based power line 36-side in the second booster circuit 62; an inter-terminal voltage Vb1 from a voltage sensor 50a placed between terminals of the first battery 50; a charge-discharge current Ib1 from a current sensor 50b mounted to the output terminal of the first battery 50; a battery temperature Tb1 from a temperature sensor 50c mounted to the first battery 50; an inter-terminal voltage Vb2 from a voltage sensor 60a placed between terminals of the second battery 60; a charge-discharge current Ib2 from a current sensor 60b mounted to the output terminal of the second battery 60; a battery temperature Tb2 from a temperature sensor 60c mounted to the second battery 60; an ignition signal from an ignition switch (start switch) 80; a gearshift position SP from a gearshift positions sensor 82 configured to detect an operating position of a gearshift lever 81; an accelerator position Acc from an accelerator position sensor 84 configured to detect a depression amount of an accelerator pedal 83; a brake pedal position BP from a brake pedal positions sensor 86 configured to detect a depression amount of a brake pedal 85; and a vehicle speed V from a vehicle speed sensor 88. The electronic control unit 70 outputs, via the output port, switching control signals to switching elements of the inverter 34, control signals to switching elements of the first and second booster circuits 52 and 62, and on-off control signals to the first and second relays 54 and 64. The electronic control unit 70 calculates a rotation speed Nm of the motor 32 based on the rotational position of the rotor of the motor 32 from the rotational position detection sensor 32a, calculates a state of charge SOC1 that is a ratio of the power capacity dischargeable from the first battery 50 to the total capacity, based on an integrated value of the charge-discharge current Ib1 of the first battery 50 from the current sensor 50b, and calculates a state of charge SOC2 that is a ratio of the power capacity dischargeable from the second battery 60 to the total capacity, based on an integrated value of the charge-discharge current Ib2 of the second battery 60 from the current sensor 60b.

In the electric vehicle 20 of the embodiment having the above configuration, the electronic control unit 70 sets a required torque Tr* that is required for the driveshaft 22 based on the accelerator position Acc and the vehicle speed V, sets a torque limit Tmax as an upper limit torque that may be output from the motor 32 by dividing a total maximum allowable output Woutsum obtained as the sum of maximum allowable outputs Wout1 and Wout2 that may be output from the first and the second batteries 50 and 60 by the rotation speed Nm of the motor 32, sets a torque command Tm* as a torque to be output from the motor 32 by limiting the required torque Tr* with the torque limit Tmax, and performs switching control of the switching elements of the inverter 34 to drive the motor 32 with the set torque command Tm*.

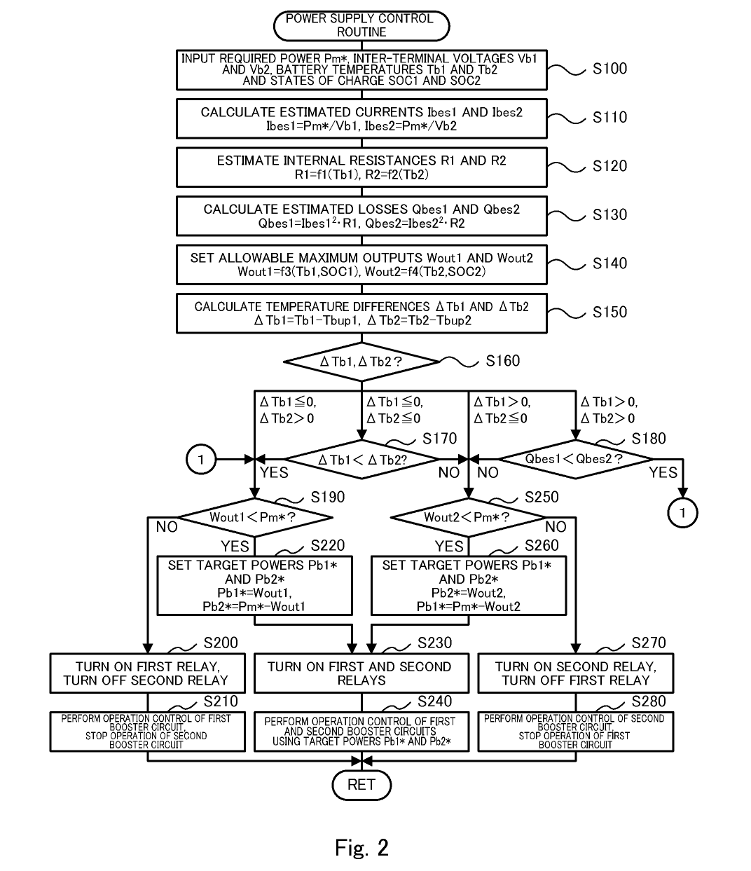

The following describes the operations of the electric vehicle 20 of the embodiment having the above configuration or more specifically describes how the electric power for driving the motor 32 is supplied from the first and the second batteries 50 and 60 to the motor 32. FIG. 2 is a flowchart showing one example of a power supply control routine performed by the electronic control unit 70 of the embodiment. This routine is performed repeatedly at predetermined time intervals (for example, at every several msec).

On start of the power supply control routine, the electronic control unit 70 first inputs data such as a required power Pm* of the motor 32, as well as the inter-terminal voltages Vb1 and Vb2, the battery temperatures Tb1 and Tb2 and the states of charge SOC1 and SOC2 of the first and the second batteries 50 and 60 (step S100). The required power Pm* of the motor 32 input here is the product of the torque command Tm* of the motor 32 set by the above drive control and the rotation speed Nm of the motor 32 calculated based on the rotational position 8m of the rotor of the motor 32 from the rotational position detection sensor 32a. The torque command Tm* of the motor 32 is set in a range of not higher than the torque limit Tmax (=Woutsum/Nm) as described above, so that the required power Pm* of the motor 32 is to be not higher than the total maximum allowable output Woutsum. The inter-terminal voltages Vb1 and Vb2 of the first and the second batteries 50 and 60 input here are values detected by the voltage sensors 50a and 60a. The battery temperatures Tb1 and Tb2 of the first and the second batteries 50 and 60 input here are values detected by the temperature sensors 50c and 60c. The states of charge SOC1 and SOC2 of the first and the second batteries 50 and 60 input here are values calculated based on the integrated values of the charge-discharge currents Ib1 and Ib2 of the first and the second batteries 50 and 60 from the current sensors 50b and 60b.

After the data input, the electronic control unit 70 calculates estimated currents Ibes1 and Ibes2 of the first and the second batteries 50 and 60 by dividing the input required power Pm* of the motor 32 by the inter-terminal voltages Vb1 and Vb2 of the first and the second batteries 50 and 60 according to Equations (1) and (2) given below (step S110). The estimated current Ibes1 of the first battery 50 denotes an electric current expected to be output from the first battery 50 when the first relay 54 is turned on to connect the first battery 50 with the first booster circuit 52 and the second relay 64 is turned off to disconnect the second battery 60 from the second booster circuit 62. The estimated current Ibes2 of the second battery 60 denotes an electric current expected to be output from the second battery 60 when the second relay 64 is turned on to connect the second battery 60 with the second booster circuit 62 and the first relay 54 is turned off to disconnect the first battery 50 from the first booster circuit 52.

Ibes1=Pm*/Vb1 (1)

Ibes2=Pm*/Vb2 (2)

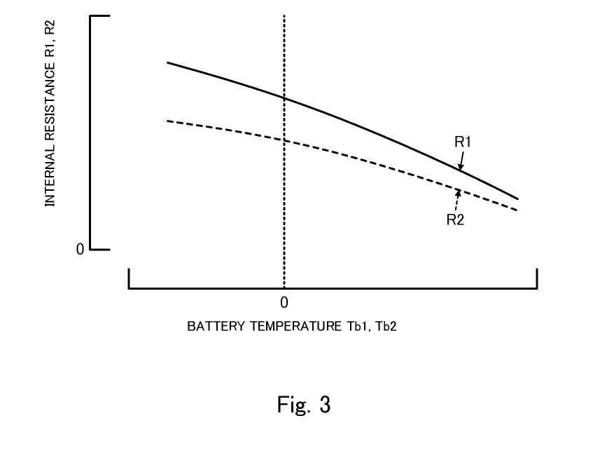

Subsequently the electronic control unit 70 estimates internal resistances R1 and R2 of the first and the second batteries 50 and 60, based on the battery temperatures Tb1 and Tb2 of the first and the second batteries 50 and 60 (step S120). According to this embodiment, a procedure of setting the internal resistances R1 and R2 of the first and the second batteries 50 and 60 stores relationships between the battery temperatures Tb1 and Tb2 and the internal resistances R1 and R2 which are determined in advance by experiment or by analysis, in the form of an internal resistance estimation map in the ROM (not shown) and reads the internal resistances R1 and R2 corresponding to given battery temperatures Tb1 and Tb2 from the stored map. One example of the internal resistance estimation map is shown in FIG. 3. In the illustrated example of FIG. 3, the internal resistance R1 is set to be greater than the internal resistance R2 at identical battery temperatures Tb1 and Tb2. This difference between the internal resistances R1 and R2 may be attributed to a difference in specification including differences between characteristics of the first and the second batteries 50 and 60 (high-capacity, high-power).

The electronic control unit 70 then calculates estimated losses Qbes1 and Qbes2 of the first and the second batteries 50 and 60 by multiplying the estimated currents Ibes1 and Ibes2 of the first and the second batteries 50 and 60 by the internal resistances R1 and R2 according to Equations (3) and (4) given below (step S130). The estimated loss Qbes1 of the first battery 50 denotes a loss expected to arise in the first battery 50 when the first relay 54 is turned on to connect the first battery 50 with the first booster circuit 52 and the second relay 64 is turned off to disconnect the second battery 60 from the second booster circuit 62. The estimated loss Qbes2 of the second battery 60 denotes a loss expected to arise in the second battery 60 when the second relay 64 is turned on to connect the second battery 60 with the second booster circuit 62 and the first relay 54 is turned off to disconnect the first battery 50 from the first booster circuit 52.

Qbes=Ibes1²·R1 (3)

Qbes=Ibes2²·R1 (4)

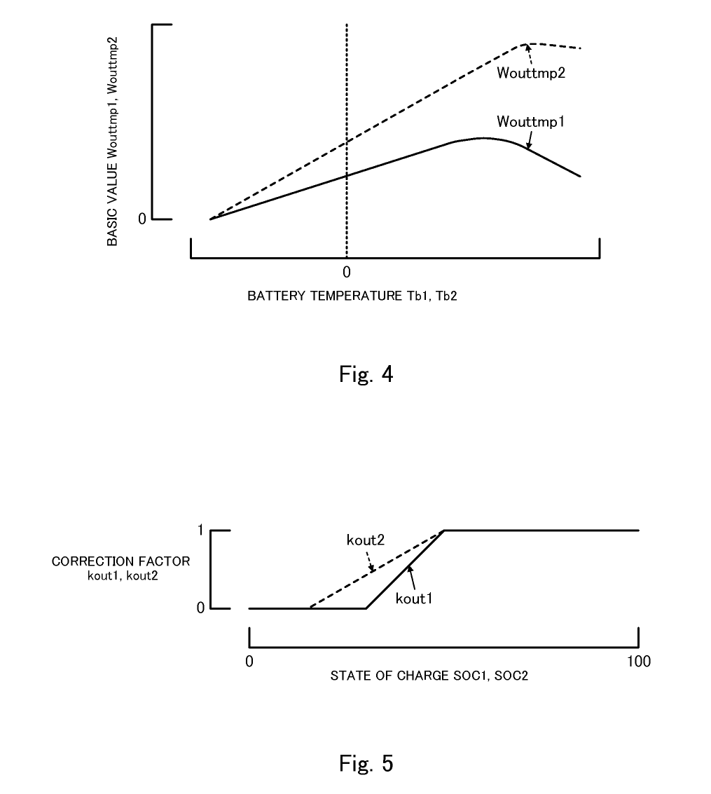

The electronic control unit 70 subsequently sets maximum allowable outputs Wout1 and Wout2 of the first and the second batteries 50 and 60 based on the temperatures Tb1 and Tb2 and the states of charge SOC1 and SOC2 of the first and the second batteries 50 and 60 (step S140). According to this embodiment, a procedure of setting the maximum allowable outputs Wout1 and Wout2 of the first and the second batteries 50 and 60 sets basic values Wouttmp1 and Wouttmp2 of the maximum allowable outputs Wout1 and Wout2 of the first and the second batteries 50 and 60 based on the battery temperatures Tb1 and Tb2, sets correction factors kout1 and kout2 based on the states of charge SOC1 and SOC2 of the first and the second batteries 50 and 60 and multiplies the set basic values Wouttmp1 and Wouttmp2 by the correction factors kout1 and kout2. FIG. 4 shows one example of the relationships between the battery temperatures Tb1 and Tb2 of the first and the second batteries 50 and 60 and the basic values Wouttmp1 and Wouttmp2. FIG. 5 shows one example of the relationships between the states of charge SOC1 and SOC2 of the first and the second batteries 50 and 60 and the correction factors kout1 and kout2. In the illustrated example of FIG. 4, the basic value Wouttmp2 is set to be greater than the basic value Wouttmp1 at identical battery temperatures Tb1 and Tb2. In the illustrated example of FIG. 5, the correction factor kout2 is set to be greater than the correction factor kout1 at identical states of charge SOC1 and SOC2. The difference between the basic values Wouttmp1 and Wouttmp2 and the difference between the correction factors kout1 and kout2 may be attributed to the difference in specification including the differences between the characteristics of the first and the second batteries 50 and 60 (high-capacity, high-power).

The electronic control unit 70 then calculates temperature differences ΔTb1 and ΔTb2 by subtracting upper limit temperatures Tbup1 and Tbup2 of required temperature rises of the first and the second batteries 50 and 60 from the battery temperatures Tb1 and Tb2 of the first and the second batteries 50 and 60 according to Equations (5) and (6) given below (step S150). Each of the upper limit temperatures Tbup1 and Tbup2 may be set to, for example, 0° C., 5° C. or 10° C.

ΔTb1=Tb1−Tbup1 (5)

ΔTb2=Tb2−Tbup2 (6)

The electronic control unit 70 subsequently compares the calculated temperature differences ΔTb1 and ΔTb2 with a value 0 (step S160). When the temperature difference ΔTb1 is equal to or less than 0 and the temperature difference ΔTb2 is greater than 0, the electronic control unit 70 determines that a temperature rise is required for the first battery 50 but is not required for the second battery 60 and compares the maximum allowable output Wout1 of the first battery 50 with the required power Pm* of the motor 32 (step S190). This process determines whether only the electric power from the first battery 50 is sufficient to cover the required power Pm* of the motor 32.

When the maximum allowable output Wout1 of the first battery 50 is equal to or greater than the required power Pm* of the motor 32 at step S190, it is determined that only the electric power from the first battery 50 is sufficient to cover the required power Pm* of the motor 32. The electronic control unit 70 then turns on the first relay 54 to connect the first battery 50 with the first booster circuit 52 while turning off the second relay 64 to disconnect the second battery 60 from the second booster circuit 62 (step S200), performs operation control of the first booster circuit 52 while stopping operation of the second booster circuit 62 (step S210) and terminates this routine. A procedure of the operation control of the first booster circuit 52 may, for example, set a target voltage VH* of the drive voltage-based power line 36 such as to increase with an increase in torque command Tm* or the rotation speed Nm of the motor 32 and control the first booster circuit 52 to approximate the voltage VH of the drive voltage-based power line 36 to the target voltage VH*.

Such control causes the required power Pm* of the motor 32 to be supplied from the first battery 50 to the motor 32 (discharged from the first battery 50), so as to raise the temperature of the first battery 50. This results in suppressing a relative increase in time required for a temperature rise of the first battery 50 due to the less frequency of discharge from the first battery 50.

When the maximum allowable output Wout1 of the first battery 50 is less than the required power Pm* of the motor 32 at step S190, on the other hand, it is determined that the electric power from the first battery 50 alone is insufficient to cover the required power Pm* of the motor 32. The electronic control unit 70 then sets the maximum allowable output Wout1 of the first battery 50 to a target power Pb1* of the first battery 50 and sets a value (Pm*−Wout1) by subtracting the maximum allowable output Wout1 of the first battery 50 from the required power Pm* of the motor 32 to a target power Pb2* of the second battery 60 (step S220). The electronic control unit 70 subsequently turns on both the first and the second relays 54 and 64 to connect the first battery 50 with the first booster circuit 52 and connect the second battery 60 with the second booster circuit 62 (step S230), performs operation control of the first and the second booster circuits 52 and 62 using the target powers Pb1* and Pb2* (step S240) and terminates this routine. The required power Pm* of the motor 32 is equal to or less than the total maximum allowable output Woutsum as described above, so that the target power Pb2* of the second battery 60 is equal to or less than the maximum allowable output Wout2 of the second battery 60. A procedure of the operation control of the first and the second booster circuits 52 and 62 may, for example, set the target voltage VH* of the drive voltage-based power line 36 such as to increase with an increase in torque command Tm* or the rotation speed Nm of the motor 32, control the first booster circuit 52 to approximate the voltage VH of the drive voltage-based power line 36 to the target voltage VH* and control the second booster circuit 62 to approximate the electric power discharged from the second battery 60 to the target power Pb2*.

Such control causes the required power Pm* of the motor 32 to be supplied from the first and the second batteries 50 and 60 to the motor 32, so as to raise the temperature of the first battery 50 and output a greater power from the motor 32 to the driveshaft 22 compared with a configuration that supplies electric power from only the first battery 50 to the motor 32 (and supplies no electric power from the second battery 60 to the motor 32). Additionally, the maximum allowable output Wout1 is supplied from the first battery 50 to the motor 32, while the electric power of the value (Pm*−Wout1) is supplied from the second battery 60 to the motor 32. This increases heat generation in the first battery 50 and thereby ensures a quicker temperature rise of the first battery 50.

When the temperature difference ΔTb1 is greater than 0 and the temperature difference ΔTb2 is equal to or less than 0 at step S160, on the other hand, the electronic control unit 70 determines that a temperature rise is not required for the first battery 50 but is required for the second battery 60 and compares the maximum allowable output Wout2 of the second battery 60 with the required power Pm* of the motor 32 (step S250). This process determines whether only the electric power from the second battery 60 is sufficient to cover the required power Pm* of the motor 32.

When the maximum allowable output Wout2 of the second battery 60 is equal to or greater than the required power Pm* of the motor 32 at step S250, it is determined that only the electric power from the second battery 60 is sufficient to cover the required power Pm* of the motor 32. The electronic control unit 70 then turns on the second relay 64 to connect the second battery 60 with the second booster circuit 62 while turning off the first relay 54 to disconnect the first battery 50 from the first booster circuit 52 (step S270), performs operation control of the second booster circuit 62 while stopping operation of the first booster circuit 52 (step S280) and terminates this routine. A procedure of the operation control of the second booster circuit 62 may, for example, set a target voltage VH* of the drive voltage-based power line 36 such as to increase with an increase in torque command Tm* or the rotation speed Nm of the motor 32 and control the second booster circuit 62 to approximate the voltage VH of the drive voltage-based power line 36 to the target voltage VH*.

Such control causes the required power Pm* of the motor 32 to be supplied from the second battery 60 to the motor 32 (discharged from the second battery 60), so as to raise the temperature of the second battery 60. This results in suppressing a relative increase in time required for a temperature rise of the second battery 60 due to the less frequency of discharge from the second battery 60.

When the maximum allowable output Wout2 of the second battery 60 is less than the required power Pm* of the motor 32 at step S250, on the other hand, it is determined that the electric power from the second battery 60 alone is insufficient to cover the required power Pm* of the motor 32. The electronic control unit 70 then sets the maximum allowable output Wout2 of the second battery 60 to the target power Pb2* of the second battery 60 and sets a value (Pm*−Wout2) by subtracting the maximum allowable output Wout2 of the second battery 60 from the required power Pm* of the motor 32 to the target power Pb1* of the first battery 50 (step S260). The electronic control unit 70 subsequently turns on both the first and the second relays 54 and 64 to connect the first battery 50 with the first booster circuit 52 and connect the second battery 60 with the second booster circuit 62 (step S230), performs operation control of the first and the second booster circuits 52 and 62 using the target powers Pb1* and Pb2* (step S240) and terminates this routine. The required power Pm* of the motor 32 is equal to or less than the total maximum allowable output Woutsum as described above, so that the target power Pb1* of the first battery 50 is equal to or less than the maximum allowable output

Wout1 of the first battery 50. A procedure of the operation control of the first and the second booster circuits 52 and 62 may, for example, set the target voltage VH* of the drive voltage-based power line 36 such as to increase with an increase in torque command Tm* or the rotation speed Nm of the motor 32, control the first booster circuit 52 to approximate the voltage VH of the drive voltage-based power line 36 to the target voltage VH* and control the second booster circuit 62 to approximate the electric power discharged from the second battery 60 to the target power Pb2*.

Such control causes the required power Pm* of the motor 32 to be supplied from the first and the second batteries 50 and 60 to the motor 32, so as to raise the temperature of the second battery 60 and output a greater power from the motor 32 to the driveshaft 22 compared with a configuration that supplies electric power from only the second battery 60 to the motor 32 (and supplies no electric power from the first battery 50 to the motor 32). Additionally, the maximum allowable output Wout2 is supplied from the second battery 60 to the motor 32, while the electric power of the value (Pm*−Wout2) is supplied from the first battery 50 to the motor 32. This increases heat generation in the second battery 60 and thereby ensures a quicker temperature rise of the second battery 60.

When the temperature differences ΔTb1 and ΔTb2 are both equal to or less than 0 at step S160, the electronic control unit 70 determines that a temperature rise is required for both the first battery 50 and the second battery 60 and compares the temperature difference ΔTb1 with the temperature difference ΔTb2 (step S170). This process identifies a battery having a greater discrepancy between the battery temperature Tb1 or Tb2 and the upper limit temperature Tbup1 or Tbup2 out of the first and the second batteries 50 and 60 (i.e., a battery to be preferentially subjected to a temperature rise).

When the temperature difference ΔTb1 is less than the temperature difference ΔTb2 (ΔTb1<ΔTb2≦0) at step S170, the electronic control unit 70 determines that a temperature rise of the first battery 50 is to be performed preferentially and performs the processing of and after step S190 (described above). More specifically, the electronic control unit 70 compares the maximum allowable output Wout1 of the first battery 50 with the required power Pm* of the motor 32 (step S190). When the maximum allowable output Wout1 of the first battery 50 is equal to or greater than the required power Pm* of the motor 32, the electronic control unit 70 turns on the first relay 54 while turning off the second relay 64 (step S200) and performs operation control of the first booster circuit 52 while stopping operation of the second booster circuit 62 (step S210). Such control causes the required power Pm* of the motor 32 to be supplied from the first battery 50 to the motor 32, so as to raise the temperature of the first battery 50. When the maximum allowable output Wout1 of the first battery 50 is less than the required power Pm* of the motor 32 at step S190, on the other hand, the electronic control unit 70 sets the maximum allowable output Wout1 of the first battery 50 to the target power Pb1* of the first battery 50 and sets the value (Pm*−Wout1) to the target power Pb2* of the second battery 60 (step S220). The electronic control unit 70 then turns on both the first and the second relays 54 and 64 (step S230) and performs operation control of the first and the second booster circuits 52 and 62 using the target powers Pb1* and Pb2* (step S240). Such control causes the required power Pm* of the motor 32 to be supplied from the first and the second batteries 50 and 60 to the motor 32, so as to raise the temperature of the first battery 50 and output a greater power from the motor 32 to the driveshaft 22 compared with the configuration that supplies electric power from only the first battery 50 to the motor 32. Additionally, the maximum allowable output Wout1 is supplied from the first battery 50 to the motor 32. This increases heat generation in the first battery 50 and thereby ensures a quicker temperature rise of the first battery 50.

When the temperature difference ΔTb1 is equal to or greater than the temperature difference ΔTb2 (0≧ΔTb1≧ΔTb2) at step S170, on the other hand, the electronic control unit 70 determines that a temperature rise of the second battery 60 is to be performed preferentially and performs the processing of and after step S250 (described above). More specifically, the electronic control unit 70 compares the maximum allowable output Wout2 of the second battery 60 with the required power Pm* of the motor 32 (step S250). When the maximum allowable output Wout2 of the second battery 60 is equal to or greater than the required power Pm* of the motor 32, the electronic control unit 70 turns on the second relay 64 while turning off the first relay 54 (step S270) and performs operation control of the second booster circuit 62 while stopping operation of the first booster circuit 52 (step S280). Such control causes the required power Pm* of the motor 32 to be supplied from the second battery 60 to the motor 32, so as to raise the temperature of the second battery 60. When the maximum allowable output Wout2 of the second battery 60 is less than the required power Pm* of the motor 32 at step S250, on the other hand, the electronic control unit 70 sets the maximum allowable output Wout2 of the second battery 60 to the target power Pb2* of the second battery 60 and sets the value (Pm*−Wout2) to the target power Pb1* of the first battery 50 (step S260). The electronic control unit 70 then turns on both the first and the second relays 54 and 64 (step S230) and performs operation control of the first and the second booster circuits 52 and 62 using the target powers Pb1* and Pb2* (step S240). Such control causes the required power Pm* of the motor 32 to be supplied from the first and the second batteries 50 and 60 to the motor 32, so as to raise the temperature of the second battery 60 and output a greater power from the motor 32 to the driveshaft 22 compared with the configuration that supplies electric power from only the second battery 60 to the motor 32. Additionally, the maximum allowable output Wout2 is supplied from the second battery 60 to the motor 32. This increases heat generation in the second battery 60 and thereby ensures a quicker temperature rise of the second battery 60.

When both the temperature differences ΔTb1 and ΔTb2 are greater than 0 at step S160, the electronic control unit 70 determines that a temperature rise is required neither for the first battery 50 nor for the second battery 60 and compares the estimated loss Qbes1 of the first battery 50 with the estimated loss Qbes2 of the second battery 60 (step S180). When the estimated loss Qbes1 of the first battery 50 is less than the estimated loss Qbes2 of the second battery 60, the electronic control unit 70 determines that a loss arising in the first battery 50 during supply of electric power from the first battery 50 to the motor 32 is less than a loss arising in the second battery 60 during supply of electric power from the second battery 60 to the motor 32 and performs the processing of and after step S190. More specifically, the electronic control unit 70 compares the maximum allowable output Wout1 of the first battery 50 with the required power Pm* of the motor 32 (step S190). When the maximum allowable output Wout1 of the first battery 50 is equal to or greater than the required power Pm* of the motor 32, the electronic control unit 70 turns on the first relay 54 while turning off the second relay 64 (step S200) and performs operation control of the first booster circuit 52 while stopping operation of the second booster circuit 62 (step S210). Such control causes the required power Pm* of the motor 32 to be supplied from the first battery 50 to the motor 32, so as to reduce a loss during supply of electric power to the motor 32 compared with supply of the required power Pm* from the second battery 60 to the motor 32. When the maximum allowable output Wout1 of the first battery 50 is less than the required power Pm* of the motor 32 at step S190, on the other hand, the electronic control unit 70 sets the maximum allowable output Wout1 of the first battery 50 to the target power Pb1* of the first battery 50 and sets the value (Pm*−Wout1) to the target power Pb2* of the second battery 60 (step S220). The electronic control unit 70 then turns on both the first and the second relays 54 and 64 (step S230) and performs operation control of the first and the second booster circuits 52 and 62 using the target powers Pb1* and Pb2* (step S240). Such control causes the required power Pm* of the motor 32 to be supplied from the first and the second batteries 50 and 60 to the motor 32, so as to output a greater power from the motor 32 to the driveshaft 22 compared with the configuration that supplies electric power from only the first battery 50 to the motor 32. Additionally, the maximum allowable output Wout1 is supplied from the first battery 50 to the motor 32, while the electric power of the value (Pm*−Wout1) is supplied from the second battery 60 to the motor 32. This relatively reduces a total loss of the first and the second batteries 50 and 60 during supply of the required power Pm* from the first and the second batteries 50 and 60 to the motor 32.

When the estimated loss Qbes1 of the first battery 50 is equal to or greater than the estimated loss Qbes2 of the second battery 60 at step S180, on the other hand, the electronic control unit 70 determines that the loss arising in the first battery 50 during supply of electric power from the first battery 50 to the motor 32 is equal to or greater than the loss arising in the second battery 60 during supply of electric power from the second battery 60 to the motor 32 and performs the processing of and after step S250. More specifically, the electronic control unit 70 compares the maximum allowable output Wout2 of the second battery 60 with the required power Pm* of the motor 32 (step S250). When the maximum allowable output Wout2 of the second battery 60 is equal to or greater than the required power Pm* of the motor 32, the electronic control unit 70 turns on the second relay 64 while turning off the first relay 54 (step S270) and performs operation control of the second booster circuit 62 while stopping operation of the first booster circuit 52 (step S280). Such control causes the required power Pm* of the motor 32 to be supplied from the second battery 60 to the motor 32, so as to reduce a loss during supply of electric power to the motor 32 compared with supply of the required power Pm* from the first battery 50 to the motor 32. When the maximum allowable output Wout2 of the second battery 60 is less than the required power Pm* of the motor 32 at step S250, on the other hand, the electronic control unit 70 sets the maximum allowable output Wout2 of the second battery 60 to the target power Pb2* of the second battery 60 and sets the value (Pm*−Wout2) to the target power Pb1* of the first battery 50 (step S260). The electronic control unit 70 then turns on both the first and the second relays 54 and 64 (step S230) and performs operation control of the first and the second booster circuits 52 and 62 using the target powers Pb1* and Pb2* (step S240). Such control causes the required power Pm* of the motor 32 to be supplied from the first and the second batteries 50 and 60 to the motor 32, so as to output a greater power from the motor 32 to the driveshaft 22 compared with the configuration that supplies electric power from only the second battery 60 to the motor 32. Additionally, the maximum allowable output Wout2 is supplied from the second battery 60 to the motor 32. This relatively reduces a total loss of the first and the second batteries 50 and 60 during supply of the required power Pm* from the first and the second batteries 50 and 60 to the motor 32.

In the electric vehicle 20 of the embodiment described above, in the case that a temperature rise is required for only the first battery 50 out of the first and the second batteries 50 and 60, the first relay 54 is turned on to connect the first battery 50 with the first booster circuit 52 (i.e., connect the first battery 50 with the motor 32-side). In the case that a temperature rise is required for only the second battery 60, the second relay 64 is turned on to connect the second battery 60 with the second booster circuit 62 (i.e., connect the second battery 60 with the motor 32-side). This ensures a temperature rise of the temperature rise-requiring battery out of the first and the second batteries 50 and 60. This results in suppressing a relative increase in time required for a temperature rise of the temperature rise-requiring battery due to the less frequency of discharge from the temperature rise-requiring battery.

In the case that a temperature rise is required for both the first and the second batteries 50 and 60, the electric vehicle 20 of the embodiment turns on the first relay 54 when the temperature difference ΔTb1 by subtracting the upper limit temperature Tbup1 of the required temperature rise from the battery temperature Tb1 of the first battery 50 is less than the temperature difference ΔTb2 by subtracting the upper limit temperature Tbup2 of the required temperature rise from the battery temperature Tb2 of the second battery 60 (ΔTb1<ΔTb2≦0), while turning on the second relay 64 when the temperature difference ΔTb1 is equal to or greater than the temperature difference ΔTb2 (0≧ΔTb1≧ΔTb2). This ensures a temperature rise of the battery having the greater temperature difference (hereinafter referred to as “greater temperature-difference battery”) having a greater discrepancy between the battery temperature Tb1 or Tb2 and the upper limit temperature Tbup1 or Tbup2.

Additionally, in the case that a temperature rise is required for only the first battery 50 or in the case that a temperature rise is required for both the first and the second batteries 50 and 60 under the condition that the temperature difference ΔTb1 is less than the temperature difference ΔTb2, the electric vehicle 20 of the embodiment turns on both the first and the second relays 54 and 64, sets the maximum allowable output Wout1 and the value (Pm*−Wout1) respectively to the target powers Pb1* and Pb2* of the first and the second batteries 50 and 60 and controls the first and the second booster circuits 52 and 62, when the maximum allowable output Wout1 of the first battery 50 is less than the required power Pm* of the motor 32.

In the case that a temperature rise is required for only the second battery 60 or in the case that a temperature rise is required for both the first and the second batteries 50 and 60 under the condition that the temperature difference ΔTb1 is equal to or greater than the temperature difference ΔTb2, the electric vehicle 20 of the embodiment turns on both the first and the second relays 54 and 64, sets the value (Pm*−Wout2) and the maximum allowable output Wout2 respectively to the target powers Pb1* and Pb2* of the first and the second batteries 50 and 60 and controls the first and the second booster circuits 52 and 62, when the maximum allowable output Wout2 of the second battery 60 is less than the required power Pm* of the motor 32. This enables a greater power to be output from the motor 32 to the driveshaft 22 compared with a configuration that electric power is supplied to the motor 32 from only the temperature rise-requiring battery out of the first and the second batteries 50 and 60. This ensures a quicker temperature rise of the temperature rise-requiring battery when a temperature rise is required for only one of the first and the second batteries 50 and 60 or a quicker temperature rise of the greater temperature-difference battery when a temperature rise is required for both the first and the second batteries 50 and 60.

In the case that a temperature rise is required for both the first and the second batteries 50 and 60, the electric vehicle 20 of the embodiment turns on the first relay 54 and turns off the second relay 64, when the temperature difference ΔTb1 is less than the temperature difference ΔTb2 (ΔTb1<ΔTb2≦0) and the maximum allowable output Wout1 of the first battery 50 is equal to or greater than the required power Pm* of the motor 32. According to one modification, the electric vehicle may turn on both the first and the second relays 54 and 64. Similarly, in the case that a temperature rise is required for both the first and the second batteries 50 and 60, the electric vehicle 20 of the embodiment turns on the second relay 64 and turns off the first relay 54, when the temperature difference ΔTb1 is equal to or greater than the temperature difference ΔTb2 (0≧ΔTb1≧ΔTb2) and the maximum allowable output Wout2 of the second battery 60 is equal to or greater than the required power Pm* of the motor 32. According to one modification, the electric vehicle may turn on both the first and the second relays 54 and 64. In these cases, the electric vehicle may set, for example, a value (Pm*/2) to both the target powers Pb1* and Pb2* of the first and the second batteries 50 and 60 and control the first and the second booster circuits 52 and 62.

In the case that a temperature rise is required neither for the first battery 50 nor for the second battery 60, the electric vehicle 20 of the embodiment turns on the first relay 54 and turns off the second relay 64, when the estimated loss Qbes1 of the first battery 50 is less than the estimated loss Qbes2 of the second battery 60 and the maximum allowable output Wout1 of the first battery 50 is equal to or greater than the required power Pm* of the motor 32. According to one modification, the electric vehicle may turn on both the first and the second relays 54 and 64. Similarly, in the case that a temperature rise is required neither for the first battery 50 nor for the second battery 60, the electric vehicle 20 of the embodiment turns on the second relay 64 and turns off the first relay 54, when the estimated loss Qbes1 of the first battery 50 is equal to or greater than the estimated loss Qbes2 of the second battery 60 and the maximum allowable output Wout2 of the second battery 60 is equal to or greater than the required power Pm* of the motor 32. According to one modification, the electric vehicle may turn on both the first and the second relays 54 and 64. In these cases, the electric vehicle may set, for example, a value (Pm*/2) to both the target powers Pb1* and Pb2* of the first and the second batteries 50 and 60 and control the first and the second booster circuits 52 and 62.

When the allowable maximum output Wout1 of the first battery 50 is less than the required power Pm* of the motor 32 at step S190 in the power supply control routine of FIG. 2, the electric vehicle 20 of the embodiment turns on both the first and the second relays 54 and 64, sets the maximum allowable output Wout1 and the value (Pm*−Wout1) respectively to the target powers Pb1* and Pb2* of the first and the second batteries 50 and 60 and controls the first and the second booster circuits 52 and 62. According to one modification, the electric vehicle may turn on both the first and the second relays 54 and 64, set a value (Pm*/2) to both the target powers Pb1* and Pb2* of the first and the second batteries 50 and 60 and control the first and the second booster circuits 52 and 62. According to another modification, the electric vehicle may turn on the first relay 54 while turning off the second relay 64 and perform operation control of the first booster circuit 52 while stopping operation of the second booster circuit 62. In this case, the electric power of the motor 32 is limited not to the total maximum allowable output Woutsum but to the maximum allowable output Wout1 of the first battery 50. Similarly, when the allowable maximum output Wout2 of the second battery 60 is less than the required power Pm* of the motor 32 at step S250, the electric vehicle 20 of the embodiment turns on both the first and the second relays 54 and 64, sets the value (Pm*−Wout2) and the maximum allowable output Wout2 respectively to the target powers Pb1* and Pb2* of the first and the second batteries 50 and 60 and controls the first and the second booster circuits 52 and 62. According to one modification, the electric vehicle may turn on both the first and the second relays 54 and 64, set a value (Pm*/2) to both the target powers Pb1* and Pb2* of the first and the second batteries 50 and 60 and control the first and the second booster circuits 52 and 62. According to another modification, the electric vehicle may turn on the second relay 64 while turning off the first relay 54 and perform operation control of the second booster circuit 62 while stopping operation of the first booster circuit 52. In this case, the electric power of the motor 32 is limited not to the total maximum allowable output Woutsum but to the maximum allowable output Wout2 of the second battery 60.

The electric vehicle 20 of the embodiment is equipped with the first and the second booster circuits 52 and 62 that are configured to boost the electric powers from the first and the second batteries 50 and 60 and supply the boosted power to the inverter 34 and with the first and the second relays 54 and 64 that are configured to connect and disconnect the first and the second batteries 50 and 60 with and from the first and the second booster circuits 52 and 62. In a configuration that the first and the second relays 54 and 64 are not simultaneously turned on (when one is turned on, the other is unconditionally turned off), the first and the second booster circuits 52 and 62 may be omitted.

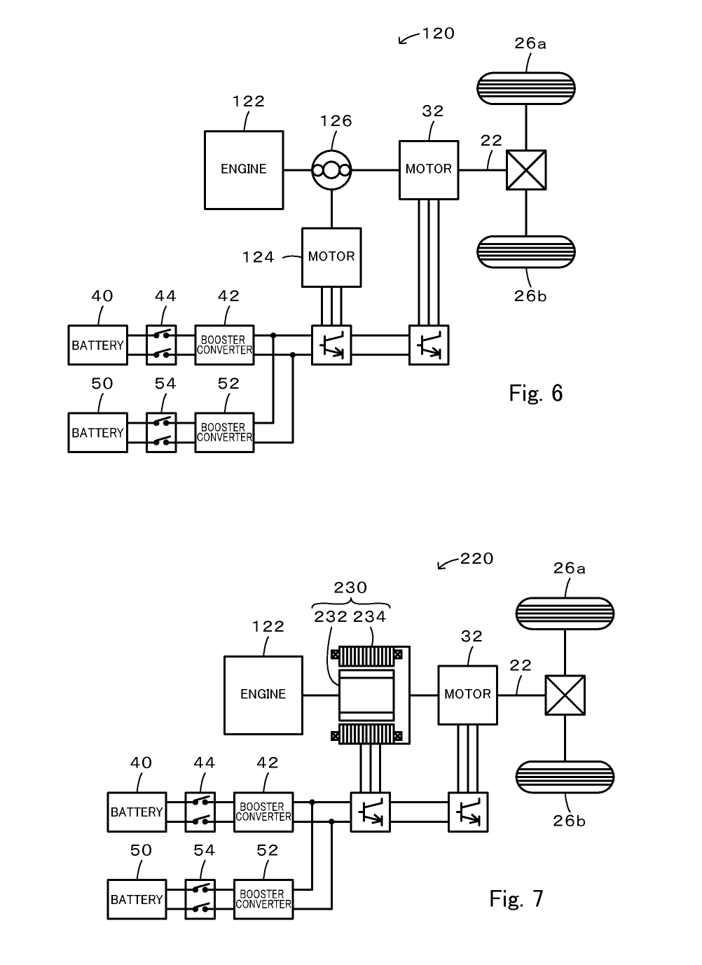

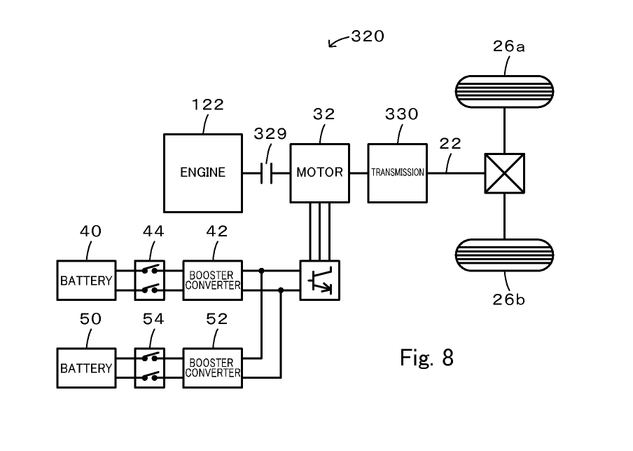

The electric vehicle 20 of the embodiment is equipped with the first and the second batteries 50 and 60 and the first and the second relays 54 and 64. The invention is, however, not limited to this configuration. For example, as shown in a modification of FIG. 6, the invention may be applied to the configuration of a hybrid vehicle 120 equipped with an engine 122 and a motor 124 that are connected with the driveshaft 22 via a planetary gear 126, in addition to the motor 32, the first and the second batteries 50 and 60 and the first and the second relays 54 and 64. As shown in another modification of FIG. 7, the invention may also be applied to the configuration of a hybrid vehicle 220 equipped with an engine 122 and a pair-rotor motor 230 that includes an inner rotor 232 connected with a crankshaft of the engine 122 and an outer rotor 234 connected with the driveshaft 22 and is configured to transmit part of the power from the engine 122 to the driveshaft 22 and convert the residual power to electric power, in addition to the motor 32, the first and the second batteries 50 and 60 and the first and the second relays 54 and 64. As shown in another modification of FIG. 8, the invention may also be applied to the configuration of a hybrid vehicle 320 equipped with a transmission 330 that is placed between the motor 32 and the driveshaft 22 and an engine 122 that is connected with a rotating shaft of the motor 32 via a clutch 329, in addition to the motor 32, the first and the second batteries 50 and 60 and the first and the second relays 54 and 64.

The following describes the correspondence relationship between the primary components of the embodiment and the primary components of the invention described in Summary of Invention. The motor 32 of the embodiment corresponds to the “motor”; the first battery 50 corresponds to the “first battery”; the first relay 54 corresponds to the “first relay”; the second battery 60 corresponds to the “second battery”; the second relay 64 corresponds to the “second relay”; and the electronic control unit 70 performing the power supply control routine of FIG. 2 corresponds to the “controller”.

In the electric vehicle of the above aspect, when a temperature rise is required for both the first and the second batteries, the controller may specify a battery having a greater temperature difference between a battery temperature and an upper limit temperature of a required temperature rise, as the selected battery out of the first and the second batteries. This ensures a temperature rise of the battery having the greater temperature difference (herein referred to as “greater temperature-difference battery”).

In the electric vehicle of the above aspect, the electric vehicle further includes: a first voltage regulating circuit that is configured to regulate a voltage of electric power from the first battery and supply the voltage-regulated electric power to the motor; and a second voltage regulating circuit that is configured to regulate a voltage of electric power from the second battery and supply the voltage-regulated electric power to the motor, wherein when a temperature rise is required for at least one of the first and the second batteries and a selected maximum allowable output that is a maximum allowable output of the selected battery is less than a required power of the motor, the controller may control the first and the second relays to connect the first and the second batteries with the motor and control the first and the second voltage regulating circuits such as to supply the selected maximum allowable output to the motor from the selected battery out of the first and the second batteries and supply a differential electric power between the required power and the selected maximum allowable output to the motor from a non-selected battery that is different from the selected battery. This enables the electric vehicle to be driven with a greater power, compared with a configuration that electric power is supplied to the motor from only the selected battery, and ensures a quicker temperature rise of the selected battery (the temperature rise-requiring battery when a temperature rise is required for one of the first and the second batteries or the greater temperature-difference battery when a temperature rise is required for both the first and the second batteries).

In the electric vehicle of the above aspect, when a temperature rise is required neither for the first battery nor for the second battery, the controller may specify a battery having a smaller loss during supply of electric power to the motor, as the selected battery out of the first and the second batteries. This reduces a loss during supply of electric power to the motor.

The correspondence relationship between the primary components of the embodiment and the primary components of the invention, regarding which the problem is described in Summary of Invention, should not be considered to limit the components of the invention, regarding which the problem is described in Summary of Invention, since the embodiment is only illustrative to specifically describes the aspects of the invention, regarding which the problem is described in Summary of Invention. In other words, the invention, regarding which the problem is described in Summary of Invention, should be interpreted on the basis of the description in the Summary of Invention, and the embodiment is only a specific example of the invention, regarding which the problem is described in Summary of Invention.

The aspect of the invention is described above with reference to the embodiment. The invention is, however, not limited to the above embodiment but various modifications and variations may be made to the embodiment without departing from the scope of the invention.

### INDUSTRIAL APPLICABILITY

The invention is applicable to, for example, the manufacturing industry of electric vehicles.

1. An electric vehicle equipped with a motor for running, a first battery, a first relay configured to connect and disconnect the first battery with and from the motor, a second battery, a second relay configured to connect and disconnect the second battery with and from the motor and a controller configured to control the motor and the first and the second relays,
wherein when a temperature rise is required for one of the first and the second batteries, the controller specifies a battery requiring a temperature rise as a selected battery out of the first and the second batteries and controls the first relay and the second relay to connect the selected battery with the motor.

2. The electric vehicle according to claim 1,
wherein when a temperature rise is required for both the first and the second batteries, the controller specifies a battery having a greater temperature difference between a battery temperature and an upper limit temperature of a required temperature rise, as the selected battery out of the first and the second batteries.

3. The electric vehicle according to claim 1, further comprising:
a first voltage regulating circuit that is configured to regulate a voltage of electric power from the first battery and supply the voltage-regulated electric power to the motor; and
a second voltage regulating circuit that is configured to regulate a voltage of electric power from the second battery and supply the voltage-regulated electric power to the motor, wherein
when a temperature rise is required for at least one of the first and the second batteries and a selected maximum allowable output that is a maximum allowable output of the selected battery is less than a required power of the motor, the controller controls the first and the second relays to connect the first and the second batteries with the motor and controls the first and the second voltage regulating circuits such as to supply the selected maximum allowable output to the motor from the selected battery out of the first and the second batteries and supply a differential electric power between the required power and the selected maximum allowable output to the motor from a non-selected battery that is different from the selected battery.

4. The electric vehicle according to claim 1,
wherein when a temperature rise is required neither for the first battery nor for the second battery, the controller specifies a battery having a smaller loss during supply of electric power to the motor, as the selected battery out of the first and the second batteries.
